(19) United States
(12) Patent Application Publication
(10) Pub. No.: US 2008/0277472 A1
(43) Pub. Date: Nov. 13, 2008

(54) TWO-DIMENSIONAL CODE SCANNER WITH GUIDE ILLUMINATION

(76) Inventor: Tohru Takahashi, Kawaguchi-shi (JP)

Correspondence Address: KAPLAN GILMAN GIBSON & DERNIER L.L.P., 900 ROUTE 9 NORTH, WOODBRIDGE, NJ, 07095, US

(21) Appl. No.: 11/746,870

(22) Filed: May 10, 2007

(51) Int. Cl. G06K 7/10

(52) U.S. Cl. 235/462.06

(57) ABSTRACT

A bar code scanner is disclosed which may include an LED. The LED includes a light source that emits light. The bar code scanner may also include a lens set. The lens set includes a back side and a front side. The front side includes a plurality of spherical lobes. When light from the light source is incident on the back side of the lens set, each of the spherical lobes preferably focuses the light into a light beam, which is then generated from each of the lobes. In certain embodiments of the invention, the LED can be mounted on the back side of a circuit board in such a fashion as to protrude through the aperture in the circuit board and then to shine light on the lens set.

### BACKGROUND OF THE INVENTION

Two-dimensional (2D) bar code scanner systems are known. In 2D bar code scanners, there have been several types of guide illumination. Each of the conventional types of guide illumination has some weak points as will be explained below.

At present, two-dimensional code scanners provide several types of guide illumination. They could be classified as follows:

1) The light source is a laser diode, and its beam is focused into a spot by a collimating lens. Although this system will allow an operator to recognize the center of the field, no information is available about the width of the field.

2) The light source is a laser diode, and a holographic module is put in front of the laser diode to produce a radial pattern. Although such an approach will locate the center of the field and the radial pattern provides the ability to measure the width of the field simultaneously, such an approach is relatively very expensive.

3) The light source comprises plural light-emitting diodes (LEDs), and a plurality of lenses disposed in front of the light-emitting diodes to generate plural beams. Although this would provide an indication of the center of the field, as well as its width, multiple diodes take too much space and are expensive.

### SUMMARY OF THE INVENTION

According to one aspect, the present invention may provide a method for using a single LED to generate light beams for use in a bar code scanner. A single LED preferably illuminates the rear of a molded lens set, resulting in each portion of the lens producing a separate beam. Also, instead of being mounted on a printed circuit board surface which is nearest to the lens, the LED may be mounted on the opposite surface of the circuit board and, in certain embodiments, protrude through it. This arrangement increases distance from the diode to the lens. As a result, the lens produces sharper beams.

One embodiment of a method according to the invention includes generating light from an LED. The method further includes using a lens set to focus the light from the LED into a plurality of focused light beams. The lens set preferably includes a back side and a front side. The front side preferably includes a plurality of spherical lobes. Each of the light beams may be emitted from a single spherical lobe.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a perspective view of a single LED that illuminates the rear of a molded lens set in accordance with one or more embodiments of the present invention.

FIG. 2 is a perspective view of the single LED and molded lens set of FIG. 1 and illuminating light therefrom in accordance with one or more embodiments of the present invention.

FIG. 3 shows a top plan view of a conventionally mounted LED.

FIG. 4 shows a top plan view of a reverse-mounted LED in accordance with one or more embodiments of the present invention.

FIG. 5 shows a schematic illustration of the advantage of lens placement according to the present invention.

### DETAILED DESCRIPTION OF THE PREFERRED EMBODIMENTS

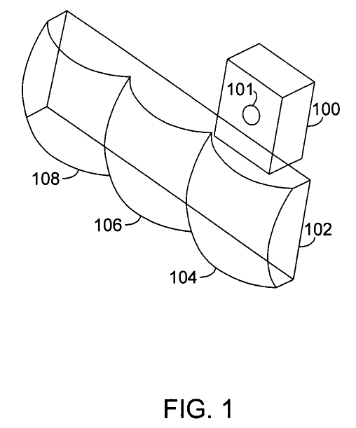

FIG. 1 shows a single LED 100 that emits light from source 101 and that illuminates the rear of a molded lens set 102 in accordance with one or more embodiments of the present invention. Molded lens set 102, which may be formed from glass, plastic or other suitable material, preferably includes a number of lenses, such as lenses (which may be referred to herein, in the alternative as “lobes”) 104, 106, and 108.

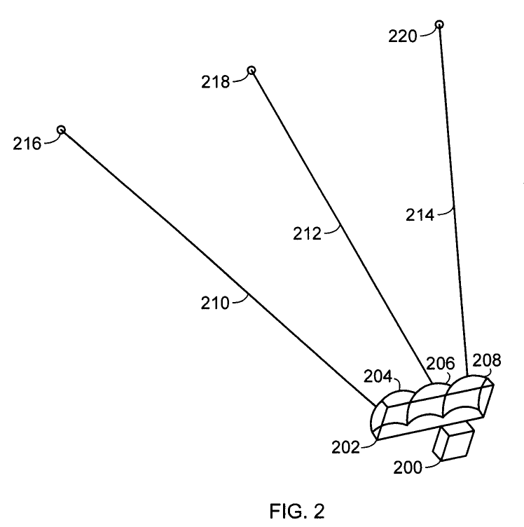

FIG. 2 shows a schematic diagram of LED 200, as well as molded lens set 202. Molded lens set 202 includes spherical lobes 204, 206, and 208. FIG. 2 shows further that a single LED 200 illuminates the rear of lens set 202 which includes lobes 204, 206, and 208. This illumination causes multiple focused beams of light 210, 212, and 214 to be emitted from lobes 204, 206, and 208. Beams of light 210, 212, and 214 preferably hit target areas to produce guide or reference dots 216, 218 and 220.

From FIG. 2 it can be seen that a single LED, when implemented according to the invention, can provide information both at the center of the field as well as information concerning the width of the field. Such an implementation preferably provides this information at a substantially reduced cost and size than is provided by the prior art systems.

It should be noted as well that when lobes according to the invention are implemented along the x-axis and y-axis with respect to the center lobe 206, information can be provided at the center of the field, at the ends of the field with respect to width, and at the ends of the field with respect to height (or length) as well. Furthermore, any spatial implementation of the lobes may be implemented in order provide additional information.

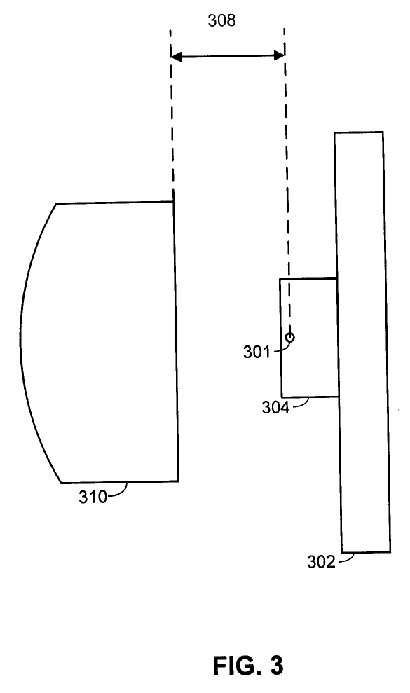

FIG. 3 provides background in order to understand another aspect of the invention. FIG. 3 shows printed circuit board 302. LED 304 is mounted on printed circuit board 302. LED emits light from source 301. The distance from source 301 to lens 310 is shown by distance 308. Distance 308 will be compared to distance 408 below in order to better understand a further aspect of the invention.

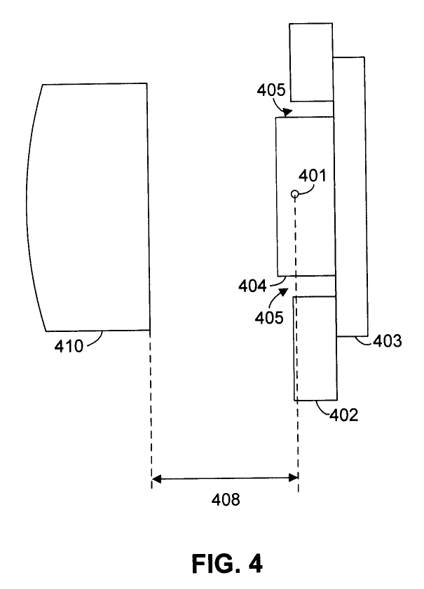

FIG. 4 illustrates a further aspect of the invention. FIG. 4 shows printed circuit board 402. LED 404 is shown as mounted on LED support structure at 403. LED 404 emits light from source 401.

A hole 405 (alternatively referred to herein as an aperture) in printed circuit board 402 is indicated at either side of LED 404. As shown, LED 404 is mounted on support structure 403 which, in turn, is mounted on the side of printed circuit board 402 which does not face lens 310. As such, distance 408, which indicates the distance from source 401 to lens 410, is relatively greater than distance 308.

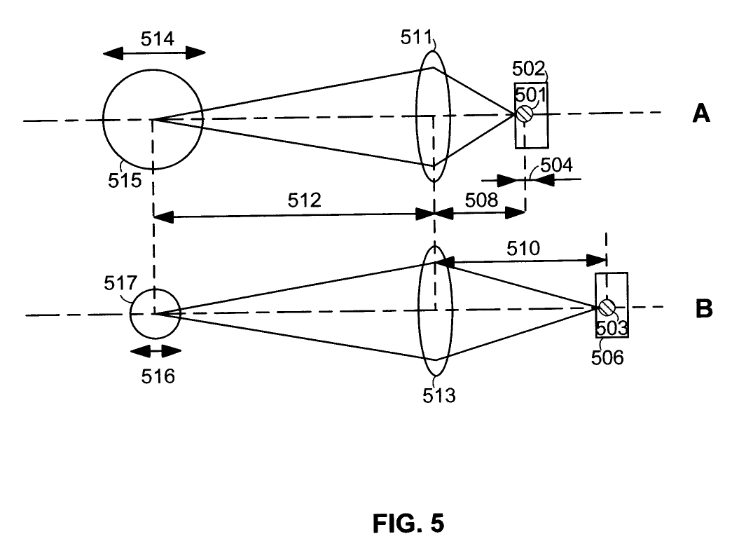

By mounting LED 404 on the side of printed circuit board 402 that does not face lens 410, and, thereby, increasing the distance between source 401 and lens 410, the power of lens 410 is increased. This phenomenon is explained in more detail with respect to FIG. 5 below.

FIG. 5 shows a schematic diagram of the optical effects of a system according to the invention. FIG. 5 shows schematic diagram A which corresponds to the implementation in FIG. 3 while schematic diagram B corresponds to the implementation in FIG. 4.

Schematic diagram A shows LED 502. LED 502 emits light from source 501. The diameter of source 501 is indicated by distance 504. The distance from the centerpoint of source 501 to the midpoint of lens 511 is indicated by distance 508. The distance from midpoint of lens 511 until the centerpoint of target area 515 is indicated by distance 512. The size 514 of target area 515 is also indicated in FIG. 5.

Schematic diagram B shows LED 506. LED 506 emits light from source 503. The diameter of source 503 is preferably the same as the diameter of source 501. The distance from the centerpoint of source 503 to the midpoint of lens 511 is indicated by distance 510. The distance from the midpoint of lens 513 until the centerpoint of target area 517 is indicated by distance 512.

Assuming all other variables to be substantially equal, the power—the power of the light, for the purposes of this application being measured in units of energy/unit space—of the lens is equal to the distance from the lens to the target divided by the distance of the lens to the source. The effect of greater power of the lens is to increase the intensity at the target area (in one embodiment of the invention, the guide dot or reference dot). Because distance 510 is greater than distance 508 (as a result of the LED being mount on the back of the circuit board and protruding therethrough), the intensity of the incident light at target area 517 is greater than the intensity of the light at target area 515. This result is clearly shown because the diameter 514 of target area 515 is substantially greater than the diameter 516 of target area 517. As such, the intensity of the light incident on target area 515 is greater than the intensity of the light incident on target area 517.

Thus, it has been shown that by mounting the LED on the side of the circuit board that is distant from the target and directing the light emitted from the LED to the target, sharper beams may be obtained because of the increased distance from the source to the lens. In one embodiment of the invention, the LED may be mounted on a structural member that is fixed to the side of the circuit board that is distant from the lens. One advantage of this embodiment is that the printed circuit board can be produced separately from the LED and then, at a different time, the LED and the structural member can be fixed to the printed circuit board.

In certain embodiments of the invention, such as the embodiments shown in FIG. 4, the LED may protrude through the hole in the printed circuit board such that the light source of the LED is located on the same side of the circuit board as the target. Alternatively, the LED may not protrude through the hole. Rather, preferably only the light from the light source may pass through the hole. Such an embodiment may provide an even sharper beam than the embodiment shown in FIG. 4, but may require a different structural member—e.g., one that protrudes further from the circuit board than the structural member shown in FIG. 4.

One advantage of sharper beams, which, in turn, produce light dots of greater intensity, is that the information derived from the light dots of greater intensity is of a higher quality than information derived from light dots of lesser intensity which are produced by less sharp beams.

One embodiment of the invention may preferably combine the two aspects of the invention disclosed herein. Thus, in this embodiment of the invention, a single LED may be mounted on the side of the printed circuit board that is distant from the lens. Furthermore, a lens set, which may include multiple spherical lobes, may be placed between the LED light source and the target areas. As such, a single LED may be implemented to provide multiple, relatively high intensity, light beams. It follows that these light beams may be used to determine information provided at the center of a target area as well as information relating to the width of the target area.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An apparatus comprising:
a light-emitting diode (LED) comprising a light source that emits light;
a lens set, said lens set comprising a back side and a front side, said front side comprising a plurality of spherical lobes; and
wherein when light from the light source is incident on the back side of the lens set, a light beam is generated from each of the lobes.

2. The apparatus of claim 1 wherein the lens set is a molded plastic lens set.

3. The apparatus of claim 1, the back side of the lens set further comprising a substantially flat back side.

4. The apparatus of claim 1, further comprising a circuit board that comprises a front side, a back side and an aperture, said front side being proximal to a light target and the back side being distal from the light target, said LED being mounted on the back side of the circuit board and protruding through the aperture in the circuit board and wherein the light from the light source is incident on the back side of the lens set.

5. The apparatus of claim 1, further comprising a circuit board that comprises a front side, a back side and an aperture, said front side being proximal to a light target and the back side being distal from the light target, said LED being mounted on a structural member, the structural member that is mounted on the back side of the circuit board, the LED that protrudes through the aperture in the circuit board and wherein the light from the light source is incident on the back side of the lens set.

6. The apparatus of claim 1, further comprising a circuit board that comprises a front side, a back side and an aperture, said front side being proximal to the lens set and the back side being distal from the lens set, said LED being mounted on the back side of the circuit board and that protrudes through the aperture in the circuit board and wherein the light from the light source is incident on the back side of the lens set.

7. The apparatus of claim 1, further comprising a circuit board that comprises a front side, a back side and an aperture, said front side being proximal to the lens set and a back side being distal from the lens set, said LED being mounted on a structural member, the structural member that is mounted on the back side of the circuit board, the LED that protrudes through the aperture in the circuit board and wherein the light from the light source is incident on the back side of the lens set.

8. A bar code scanner comprising the apparatus of claim 1.

9. A method comprising:
generating light from a light-emitting diode (LED),
focusing the light from the LED into a plurality of focused light beams using a lens set comprising a back side and a front side, said front side comprising a plurality of spherical lobes, each of said light beams emitting from a single lobe of the plurality of spherical lobes.

10. The method of claim 9, further comprising focusing using a molded plastic lens set as the lens set.

11. The method of claim 9, further comprising focusing using a lens set with a substantially flat back side.

12. The method of claim 9, further comprising mounting the LED on a circuit board that comprises a front side, a back side and an aperture, said front side being proximal to a light target and the back side being distal from the light target, said LED protruding through the aperture in the circuit board and wherein the light from the light source is incident on the back side of the lens set.

13. The method of claim 9, further comprising mounting the LED on a structural member, the structural member that is mounted on the back side of a circuit board, the circuit board that comprises a front side, a back side and an aperture, said front side being proximal to the lens set and the back side being distal from the lens set, the LED that protrudes through the aperture in the circuit board and wherein the light from the light source is incident on the back side of the lens set.

14. The method of claim 9, further comprising mounting the LED on the back side of a circuit board, the circuit board that comprises a front side, a back side and an aperture, said front side being proximal to lens set and the back side being distal from the lens set, the LED that protrudes through the aperture in the circuit board and wherein the light from the light source is incident on the back side of the lens set.

15. The method of claim 9, further comprising mounting the LED on a circuit board, the circuit board that comprises a front side, a back side and an aperture, said front side being proximal to lens set and the back side being distal from the lens set, said LED being mounted on a structural member, the structural member that is mounted on the back side of the circuit board, the LED that protrudes through the aperture in the circuit board and wherein the light from the light source is incident on the back side of the lens set.

16. An apparatus comprising:
a light-emitting diode (LED) comprising a light source that emits light;
a lens, said lens comprising a back side and a front side; and
a circuit board that comprises a front side, a back side and an aperture, said front side being proximal to the lens and a back side being distal from the lens, said LED being mounted on the back side of the circuit board and protruding through the aperture in the circuit board and wherein the light from the light source is incident on the back side of the lens set.

17. The apparatus of claim 16, the front side of the lens further comprising a plurality of spherical lobes, and wherein when light from the light source is incident on the back side of the lens, a light beam is generated from each of the lobes.

18. A bar code scanner comprising the apparatus of claim 16.

19. An apparatus comprising:
a light emitting diode (LED) comprising a light source that emits light;
a lens, said lens comprising a back side and a front side;
a circuit board that comprises a front side, a back side and an aperture, said front side being proximal to the lens and the back side being distal from the lens; and
a structural member, said LED being mounted on the structural member, said structural member being affixed to the back side of the circuit board, said LED protruding through the aperture in the circuit board and wherein the light from the light source is incident on the back side of the lens.

20. The apparatus of claim 19, said front side of the lens further comprising a plurality of spherical lobes, and wherein when light from the light source is incident on the back side of the lens, a light beam is generated from each of the lobes.

21. A bar code scanner comprising the apparatus of claim 19.
